(19) United States
(12) Patent Application Publication
(10) Pub. No.: US 2024/0385832 A1
(43) Pub. Date: Nov. 21, 2024

(54) GENERATION OF TECHNICAL DATA

(71) Applicant: MICROSOFT TECHNOLOGY LICENSING, LLC, Redmond, WA (US)

(72) Inventor: Lucien Heath NYSWONGER, Bothell, WA (US)

(21) Appl. No.: 18/199,312

(22) Filed: May 18, 2023

(51) Int. Cl. G06F 8/73; G06F 40/284; G06F 40/40

(52) U.S. Cl. CPC G06F 8/73; G06F 40/284; G06F 40/40

(57) ABSTRACT

A computer-implemented method comprises accessing source data comprising source code or data about source code. An item in the source data is found, where the item is a ticket thread in a bug ticketing system, or an error message in source code, or alt tag in source code. Criteria are checked by determining quality of the item, or determining completeness of the item, or by comparing the item with a specification. In response to criteria being met for generating technical data related to the item, prompting a large language model (LLM) with a prompt comprising the item. Technical data is received from the LLM in response to the prompt; and stored in association with the source data, or the source data is updated using the technical data.

### BACKGROUND

In regulated sectors such as telecommunications it may be mandatory to publish technical data such as product release notes comprising technical documentation describing a new software product or a software product update. Product release notes are used in a wide variety of sectors where software products are released or updated.

Error messages are another form of technical data. Operating systems and other source code typically comprises conditions which trigger error messages such as system error codes, dialog boxes containing warnings and other messages indicating that a device is not ready, access has been denied, there is no available memory, there is a page fault or other error.

Technical data in source code is also used to enable accessibility, such as to describe images using text referred to as Alt text. Alt text is a written description of an image that may be displayed where it is not possible to load the associated image (if bandwidth is not sufficient for example), where a user is unable to see an image, and provides search engines with information about the content of the image

The embodiments described below are not limited to implementations which solve any or all of the disadvantages of known technical data.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

Technical data such as software product release notes, software error messages, alternative text for images in software, is important for facilitating understanding by operators of technology. Errors or omissions in technical data lead to problems such as inefficient deployment of new software products, inefficient troubleshooting of software errors and lack of understanding. In various examples there are ways to automatically generate technical data in an accurate, efficient manner.

In various examples there is a method comprising accessing source data comprising source code or data about source code. An item in the source data is found, where the item is a ticket thread in a bug ticketing system, or an error message in source code, or alt tag in source code. Checking criteria by determining quality of the item, or determining completeness of the item, or by comparing the item with a specification. In response to criteria being met for generating technical data related to the item, prompting a large language model “LLM” with a prompt comprising the item. Receiving technical data from the LLM in response to the prompt; and storing the technical data in association with the source data or updating the source data using the technical data.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of source data accessible to a generator for generating technical data;

FIG. 2 is a schematic diagram of problem resolution threads accessible to a generator for generating release notes;

FIG. 3 is a schematic diagram of a web page comprising text and an image;

FIG. 4 is a flow diagram of a method of generating technical data;

FIG. 5 illustrates an exemplary computing-based device in which embodiments of a technical data generator are implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present examples are constructed or utilized. The description sets forth the functions of the examples and the sequence of operations for constructing and operating the examples. However, the same or equivalent functions and sequences may be accomplished by different examples.

As mentioned above, technical data such as software product release notes, software error messages, alternative text for images in software, is important for facilitating understanding by operators of technology. Errors or omissions in technical data lead to problems such as inefficient deployment of new software products, inefficient troubleshooting of software errors and lack of understanding. In various examples there are ways to automatically generate technical data in an accurate, efficient manner.

Release notes are crucial for users as they provide a comprehensive overview of the latest product changes, updates, and fixes. They allow users to make informed decisions about upgrading, better understand and utilize the product, and troubleshoot issues. Additionally, clear, and transparent communication of changes and updates builds trust with users and aids support and training teams. In certain industries such as telecommunications, release notes are typically mandatory to ensure safety, security, and compliance with industry standards and regulations and ensuring transparency and traceability of changes made to the software, further highlighting their significance in ensuring user satisfaction and product success. But they can also be complex and time-consuming to produce.

A computer-implemented method accesses source data comprising source code or data about source code. An item in the source data is found, where the item is a ticket thread in a bug ticketing system, or an error message in source code, or alt tag in source code. In this way source data which is readily available is accessed. By finding items automatically it is possible to efficiently identify items for which technical data may be generated. In response to criteria being met for generating technical data related to the item, the method prompts a large language model “LLM” with a prompt comprising the item. In this way a prompt is efficiently created in an automatic manner. Technical data is received from the LLM in response to the prompt and the technical data is stored in association with the source data. In some cases the source data is updated using the technical data (such as by modifying error messages in source code, modifying alt text in source code).

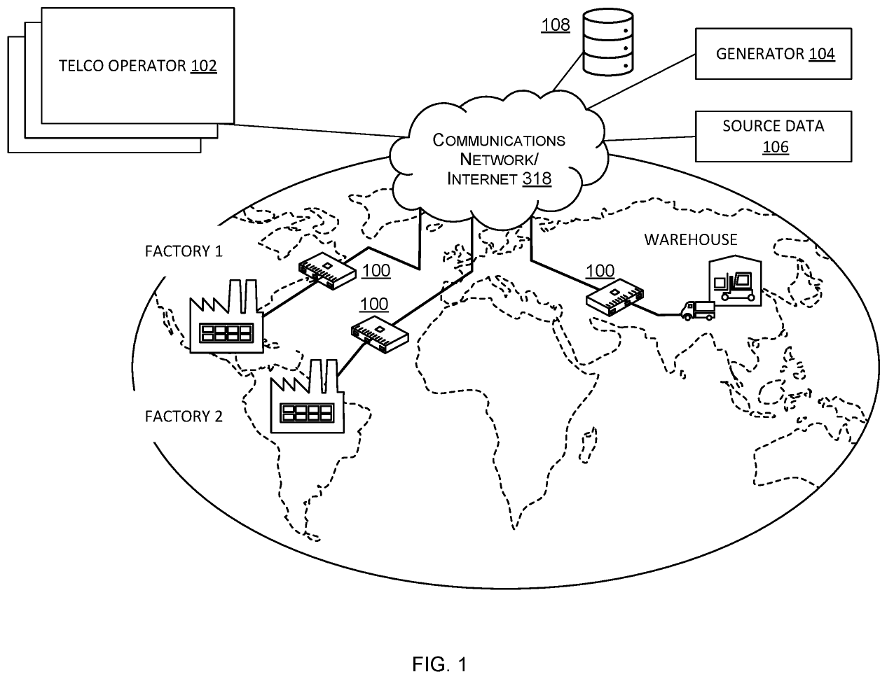

FIG. 1 is a schematic diagram of source data 106 accessible to a generator 104 for generating technical data stored in database 108. The source data is any of: ticket threads in a bug ticketing system, source code containing error messages, or source code containing alt tags. The technical data stored in database 108 is any of: product release notes, error messages, alt tags.

The generator 104 is generative machine learning functionality such as a large language model (LLM). A large language model is a neural network having millions or more parameters and comprising one or more transformer neural networks. In an example the generator is a generative pretrained transformer GPT neural network such as currently commercially available from OpenAI (trade mark). A prompt is formed using the source data 106. The generator 104 is prompted using the prompt in order to generate the technical data stored in database 108.

The example of FIG. 1 is in the context of telecommunications operators 102 using cloud services to deploy communications network technology. However, this is an example only to aid understanding of the technology and is not intended to be limiting. In the example of FIG. 1 a telco operator 102 operates a communications network at factory 1, factory 2 and warehouse where these are at different geographical locations as indicated. Factory 1 has an edge communications network connected by physical network hardware equipment 100 to a cloud service in the internet 318. Factory 2 and the warehouse also each have an edge communications network connected by physical network hardware equipment 100 to the cloud service in internet 318. The telco operator 102 is able to configure and manage communications network equipment at factory 1, factory 2 and warehouse by remote login from the internet 318 and also by using services in the cloud service in the internet 318.

When new software is released or updated the telco operator receives product release notes from a provider of the cloud services. The product release notes comprise technical data accurately detailing what the new software is, what functionality it provides and how to deploy the new software. The product release notes are very important for enabling the telco operator to efficiently and effectively operate the communications network. However, it is difficult and time consuming to create the product release notes manually so they are accurate, concise and have a consistent writing style. In various examples there are processes for automatically generating the product release notes as described in more detail below. Product release notes are also used for other types of software, not only for software used by telco operators and the technology described herein is also usable to automatically generate such product release notes.

Managing dozens of products involves generating release notes, which is a time-consuming and challenging task involving multiple individuals across various product cycles. This process allocates significant resource.

Some of the key challenges include:

Gathering information from various sources: Release notes are to be comprehensive, which means they seek to capture all the updates and changes made to the product since the last release. This can be a challenge, as information may come from different teams or departments, and it can be difficult to keep track of all the updates.

Prioritizing information: Not all updates and changes are equally important to all users, so it is important to prioritize the information in release notes based on the needs of the audience. This can be a challenge as different stakeholders may have different priorities and perspectives.

Ensuring accuracy and completeness: Release notes are to be accurate and complete to avoid misleading users and causing confusion. However, errors can occur, such as missing updates or inaccurately describing changes made, which can negatively impact the user experience.

Maintaining consistency and clarity: Release notes are to be easy to read and understand and follow consistent writing style to ensure users can quickly understand the information. However, it can be difficult to maintain consistency across multiple releases or when information is coming from different sources and different writers.

Time constraints: Release notes are to be prepared within a certain timeframe, typically tied to the release schedule. This can be challenging, as teams may work quickly to gather, prioritize, and present the information in a clear and concise manner.

Overall, pulling together release notes requires careful planning, coordination, and attention to detail to ensure accuracy, completeness, and clarity.

When software is executed and an error occurs, typically an error message is output by the software to inform a user or operator of the error. Typically error messages are manually written when source code is written. As a result, error messages are often ambiguous, unclear, lacking in detail, or comprise error code numbers which are not readily understood by a human. The generator 104 is used in some examples to generate error messages for use in source code.

When software is executed in order to display a web page or other content, often images within text documents are not displayed such as where these are blocked by a firewall, virus scanner or are not available due to bandwidth restricting their download. It is useful to display alternative text describing the image. The alternative text is a type of technical data which is generated by generator 104 in some examples.

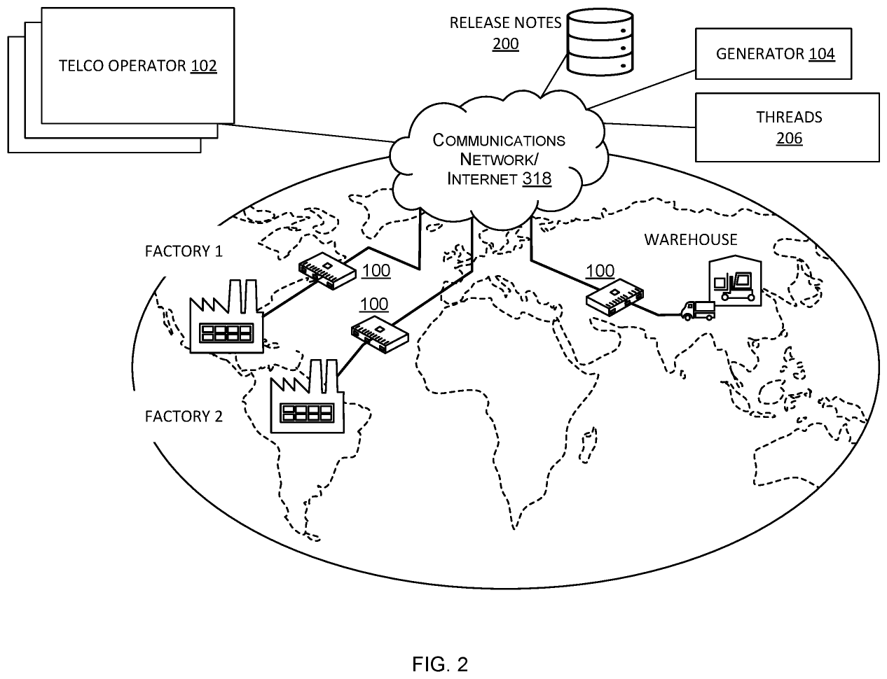

FIG. 2 is a schematic diagram of threads 206 accessible to a generator 104 for generating release notes 200. The example of FIG. 2 is described in the context of telco operators 102 as for FIG. 1 although this is not intended to be limiting as the technology can be used in other scenarios.

When a telco operator 102 experiences a bug in software used to provide the communications network service within internet 318, the telco operator 102 may log a ticket in a bug ticketing system provided in the cloud. Manufacturers of the software may also find bugs through testing and log those into the same bug ticketing system. The bug ticketing system is available to a plurality of telco operators in some examples. When a ticket is issued by a bug ticketing system, the bug ticketing system assigns a title to the ticket such as by requesting a title from a human user who requests the ticket. A thread is initiated for the ticket by the bug ticketing system. The thread is a sequence of comments which make up a conversation. The thread comprises comments which are pieces of text input by one or more different human users or automated assistants. A thread may also have a description which is one or more keywords related to the thread. The keywords may be extracted from one or more of the comments.

Software is used to find one of the threads from the ticketing system which is suitable for generating a release note. To do this a thread which is complete is selected, such as a thread which has a resolution of a bug. To identify threads which are complete software searches for keywords indicating a thread is complete.

Once a thread has been found or selected, it is used to prompt an LLM. Thus the prompt may comprise a title, description and comments of the ticket thread. In some cases the prompt specifies a technical writer role and writing style. In some cases, prior to prompting the LLM with the thread, personal data is removed from the thread in order to improve security and privacy.

An example of a prompt formed from a thread is:
requestBody={
“prompt”: f”Create a clear and concise customer-facing summary of this work item using plain English. Act as an experienced technical writer with knowledge of the telecommunications industry and expertise in the enterprise style of writing. Project friendliness. Get to the point fast. Title: \“{title}\”. Description: \“{description}.
{comment_history}\””,
“temperature”: 6,
“max_tokens””2000}

In response to the prompt the LLM generates technical data comprising a release note and the release note is stored.

Software monitors a ticketing system for bugs and efficiently extracts crucial thread details, including the title, description, comments. In some cases the removal of any sensitive personal information is done. A summary is prompted based on the data and conversation in the ticket thread and the LLM rewrites the content using a specified writing style, mimicking the tone of a professional technical writer with domain expertise. The result is a clear, concise, and well-written document aligned to specified standards. The resulting documentation is in any specified format (Word, Markdown, PDF, etc.).

The example of FIG. 2 is modified in some cases by using a pre-trained generator 104 and adapting the generator 104 to a particular deployment. In an example where the generator 104 is to be deployed for use in the telco operator 102 deployment of FIG. 2 the generator is a generative pre-trained transformer model which is subsequently fine tuned by training it using threads, source code, documents, and other content of the telco operators 102. In this way the generator 104 is able to accurately generate technical data in a manner bespoke to the telco operators 102.

The example of FIG. 2 is modified in some cases by using a generator 104 which is adapted to receive a command token as part of the prompt. A command token is interpreted by an LLM as a command rather than as a regular token and triggers the LLM to call a search engine using a query comprising key words from the prompt. In an example, the prompt comprises the key word “5G” and the command token is a first token of the prompt. The first token is populated with 5G and triggers the LLM to call a search engine using the query 5G. The response from the search engine comprises accurate factual data about 5G which is input to the LLM and used to improve factual accuracy of technical data generated by the LLM.

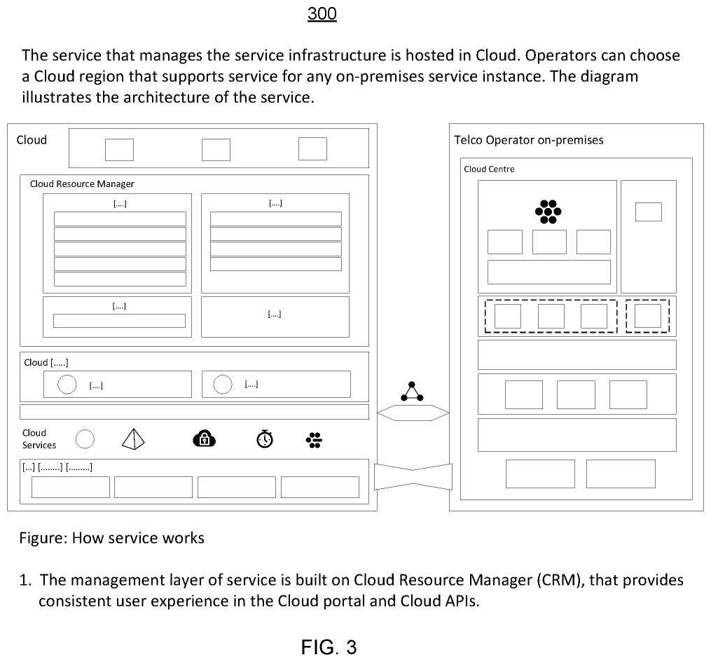

FIG. 3 is a schematic diagram of a web page 300 comprising text and an image. In this example, the text is explaining to a reader how a piece of technology works and the image also gives details about how that technology works. Mark up language source code used to generate the web page 300 comprises an alt tag for the image such that when the image cannot be displayed the alt tag is displayed in it's place. The alt tag is also helpful for accessibility requirements where there are users who are unable to view images but who can read alt tags or hear alt tags converted into speech.

An example of an alt tag in source code is
<span class “mx-imgBorder”> <img src “media/architecture overview.png” alt “Screenshot of how service works.” data-linktype “relative path”>

Often alt tags are poor quality. The present technology provides an automated way to improve alt tags. Software finds an alt tag in source code and checks whether the alt tag is high quality. This is done by determining whether criteria are met by prompting the generator to analyze the alt tag and, in response to results from the LLM indicating the alt tag is inadequate, determining the criteria are met. Prompting an LLM to analyze an alt tag comprises prompting an LLM with a query such as “Does the following alt tag meet WCAG requirements?” where WCAG is web content accessibility guidelines.

If the LLM response indicates that the alt tag does not meet WCAG requirements, the software prompts the LLM with a prompt comprising the alt tag, source code around the alt tag, and a request to improve the alt tag. The LLM generates an improved version of the alt tag. The source code is then updated with the technical data, in this case the improved version of the alt tag.

In some cases the prompt comprises an image associated with the alt tag. In this case the prompt comprises an image and at least a request to generate an alt tag for the image. Where the prompt comprises an image, a multi modal generative neural network is used which is able to take both images and text as input. An example of a currently commercially available multi model generative neural network is GPT-4 (trade mark).

Where the LLM response indicates that the alt tag already meets WCAG requirements, the software proceeds to find a next alt tag for checking.

In some examples, the technical data is error messages. Software searches source code for an error message and determines whether criteria are met by prompting an LLM to analyze the error message. If the LLM responds indicating the error message is inadequate since it is not concise or is unclear, the LLM is prompted with a prompt comprising the error message, source code around the error message and a request to improve the error message.

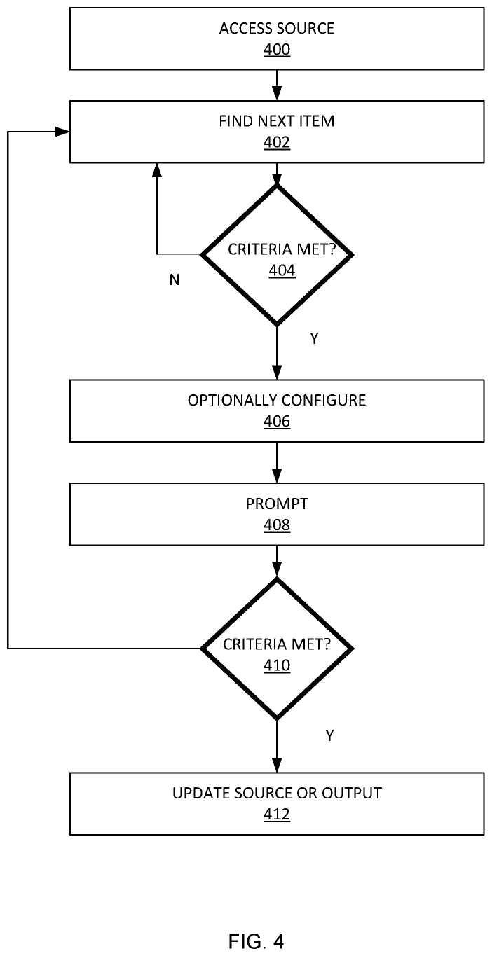

In various examples a human in the loop process is used prior to use of generated technical data as now explained with reference to FIG. 4.

FIG. 4 is a flow diagram of a method of generating technical data. The method of FIG. 4 is executed by a computing entity such as a compute node in a data centre, a server or any other computing device. A source of data is accessed 400 such as threads in a bug ticketing system, source code from a source code repository. An item in the source is found 402 such as by searching for a completed thread or by searching for an error message or by searching for an alt tag. The process determines criteria by determining quality of the item, or determining completeness of the item, or by comparing the item with a specification. A check is made 404 as to whether the criteria are met. The check may comprise determining whether a thread is complete. The check may comprise prompting an LLM to check whether an error message is high quality. The check may comprise prompting an LLM to check whether an alt tag meets WCAG specification.

If the criteria are not met the process returns to operation 402 and finds a next item. If the criteria are met the process optionally configures 406 the LLM. Optionally configuring the LLM may comprise assigning a role of technical writer to the LLM and assigning a writing style to the LLM.

In an example, the optionally configuring operation 406 comprises sending a prompt to the LLM as follows “assuming you are an accessibility expert familiar with all WCAG guidelines, draft ALT tag text for images that is both succinct and accurate. Don't be too verbose. Focus on providing specific descriptions and incorporating relevant keywords to convey valuable context. Avoid using phrases like “picture of” or “image of” in your descriptions. The ALT text should be meaningful within the context of the surrounding content.”

A prompt 408 is input to the LLM. In some cases the prompt comprises a thread from a ticketing system. In some cases the prompt comprises an alt tag or an error message. In response to the prompt the LLM generates technical data.

At check 410 a human assesses the technical data and if the human determines the technical data is accurate and clear the process moves to operation 412 where the source is updated using the technical data, or the technical data is output. If the human determines criteria are not met the process returns to operation 402.

The process of FIG. 4 is modified in some cases by omitting human in the loop operation 410.

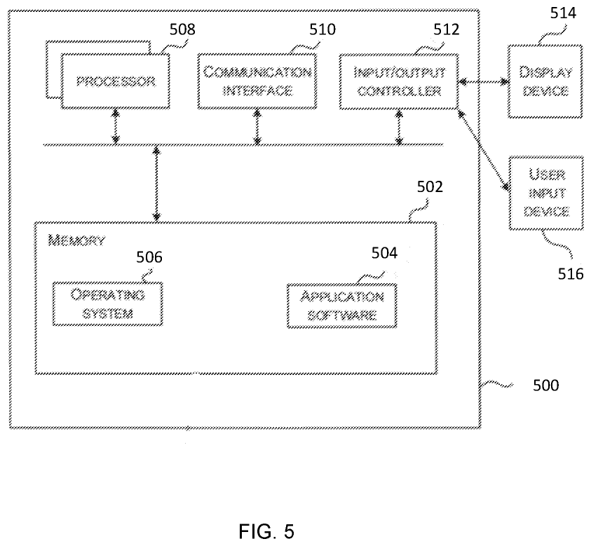

FIG. 5 illustrates an exemplary computing-based device 500 in which embodiments of a technical data generator are implemented. Computing-based device 500 is a node in a data centre, or a server, or a personal computer or any other computing device.

Computing-based device 500 comprises one or more processors 508 which are microprocessors, controllers or any other suitable type of processors for processing computer executable instructions to control the operation of the device in order to automatically generate technical data. In some examples, for example where a system on a chip architecture is used, the processors 508 include one or more fixed function blocks (also referred to as accelerators) which implement a part of the method of automatically generating technical data in hardware (rather than software or firmware). Platform software comprising an operating system 506 or any other suitable platform software is provided at the computing-based device to enable application software 504 to be executed on the device.

The computer executable instructions are provided using any computer-readable media that is accessible by computing-based device 500. Computer-readable media includes, for example, computer storage media such as memory 502 and communications media. Computer storage media, such as memory 502, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is used to store information for access by a computing device. In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 502) is shown within the computing-based device 500 it will be appreciated that the storage is, in some examples, distributed or located remotely and accessed via a network or other communication link (e.g. using communication interface 510).

The computing-based device 500 also comprises an input/output controller 512 arranged to output display information to a display device 514 which may be separate from or integral to the computing-based device 500. The display information may provide a graphical user interface. The input/output controller 512 is also arranged to receive and process input from one or more devices, such as a user input device 516 (e.g. a mouse, keyboard, camera, microphone or other sensor). In some examples the user input device 516 detects voice input, user gestures or other user actions and provides a natural user interface (NUI). This user input may be used to form prompts and check generated technical data. In an embodiment the display device 514 also acts as the user input device 516 if it is a touch sensitive display device. The input/output controller 512 outputs data to devices other than the display device in some examples, e.g. a locally connected printing device (not shown in FIG. 5).

Alternatively or in addition to the other examples described herein, examples include any combination of the following clauses.

Clause A. A computer-implemented method comprising:
accessing source data comprising source code or data about source code;
finding an item in the source data, where the item is a ticket thread in a bug ticketing system, or an error message in source code, or alt tag in source code;
checking criteria by determining quality of the item, or determining completeness of the item, or by comparing the item with a specification;
in response to the criteria being met for generating technical data related to the item, prompting a large language model “LLM” with a prompt comprising the item;
receiving technical data from the LLM in response to the prompt; and
storing the technical data in association with the source data, or updating the source data using the technical data.

Clause B. The method of clause A wherein the source data is data about source code comprising ticket threads in a bug ticketing system, the criteria comprise completion of a ticket thread, and the technical data is a release note for the source code.

Clause C. The method of clause B comprising checking the criteria are met by searching ticket threads for key words indicating completion of the ticket thread.

Clause D. The method of clause B comprising prompting the LLM with the ticket thread comprising a title, description and comments of the ticket thread.

Clause E. The method of any preceding clause comprising prior to prompting the LLM with the item, prompting the LLM with a technical writer role and writing style.

Clause F. The method of any preceding clause comprising prior to prompting the LLM with the item, removing personal data from the item.

Clause G. The method of any preceding clause comprising, prior to prompting the LLM, adapting the LLM by training the LLM with content from an enterprise which produces the source data.

Clause H. The method of any preceding clause wherein the item is an alt tag and wherein the method comprises determining whether the criteria are met by prompting the LLM to analyze the alt tag and, in response to results from the LLM indicating the alt tag is inadequate, determining the criteria are met.

Clause I. The method of clause H comprising, in response to determining the criteria are met, prompting the LLM with the prompt, where the prompt comprises the alt tag, source code around the alt tag and a request to improve the alt tag; and updating the source code with the technical data.

Clause J. The method of clause H comprising, in response to determining the criteria are met, prompting the LLM with the prompt, where the prompt comprises an image associated with the alt tag; and modifying the source code by adding the technical data to the alt tag.

Clause K. The method of clause H comprising in response to results from the LLM indicating the alt tag is adequate, determining the criteria are not met and finding a next item in the source data.

Clause L. The method of any preceding clause wherein the item is an error message and wherein the method comprises determining whether the criteria are met by prompting the LLM to analyze the error message and, in response to results from the LLM indicating the error message is inadequate, determining the criteria are met.

Clause M. The method of clause L comprising, in response to determining the criteria are met, prompting the LLM with the prompt, where the prompt comprises the error message, source code around the error message and a request to improve the error message.

Clause N. The method of any preceding clause comprising only storing the technical data or only updating the source data with the technical data, in response to input from an operator.

Clause O. The method of any preceding clause comprising adding a command token in the prompt where the command token triggers the LLM to call a search engine using a query comprising key words from the prompt.

Clause P. An apparatus comprising:
a processor;
a memory storing instructions which when executed on the processor implement;
accessing source data comprising source code or data about source code;
finding an item in the source data, where the item is a ticket thread in a bug ticketing system, or an error message in source code, or alt tag in source code; checking criteria by determining quality of the item, or determining completeness of the item, or by comparing the item with a specification;
in response to the criteria being met for generating technical data related to the item, prompting a large language model “LLM” with a prompt comprising the item;
receiving technical data from the LLM in response to the prompt; and
storing the technical data in association with the source data, or updating the source data using the technical data.

Clause Q. The apparatus of clause P where the instructions implement checking the criteria are met by searching ticket threads for key words indicating completion of the ticket thread.

Clause R. The apparatus of clause P where the instructions implement prompting the LLM with the ticket thread comprising a title, description and comments of the ticket thread.

Clause S. The apparatus of clause P where the instructions implement prior to prompting the LLM with the item, prompting the LLM with a technical writer role and writing style.

Clause T. A computer-implemented method comprising:
accessing source data comprising source code or data about source code;
finding an item in the source data, where the item is a ticket thread in a bug ticketing system, or an error message in source code, or alt tag in source code;
checking criteria by determining quality of the item, or determining completeness of the item, or by comparing the item with a specification;
in response to the criteria being met for generating technical data related to the item, forming a prompt from the item and a command token;
prompting a large language model “LLM” with the prompt;
receiving technical data from the LLM in response to the prompt; and storing the technical data in association with the source data, or updating the source data using the technical data.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

What is claimed is:

1. A computer-implemented method comprising:
accessing source data comprising source code or data about source code;
finding an item in the source data, where the item is a ticket thread in a bug ticketing system, or an error message in source code, or alt tag in source code;
checking criteria by determining quality of the item, or determining completeness of the item, or by comparing the item with a specification;
in response to the criteria being met for generating technical data related to the item, prompting a large language model (LLM) with a prompt comprising the item;
receiving technical data from the LLM in response to the prompt; and
storing the technical data in association with the source data, or updating the source data using the technical data.

2. The method of claim 1 wherein the source data is data about source code comprising ticket threads in a bug ticketing system, the criteria comprise completion of a ticket thread, and the technical data is a release note for the source code.

3. The method of claim 2 comprising checking the criteria are met by searching ticket threads for key words indicating completion of the ticket thread.

4. The method of claim 2 comprising prompting the LLM with the ticket thread comprising a title, description and comments of the ticket thread.

5. The method of claim 1 comprising prior to prompting the LLM with the item, prompting the LLM with a technical writer role and writing style.

6. The method of claim 1 comprising prior to prompting the LLM with the item, removing personal data from the item.

7. The method of claim 1 comprising, prior to prompting the LLM, adapting the LLM by training the LLM with content from an enterprise which produces the source data.

8. The method of claim 1 wherein the item is an alt tag and wherein the method comprises determining whether the criteria are met by prompting the LLM to analyze the alt tag and, in response to results from the LLM indicating the alt tag is inadequate, determining the criteria are met.

9. The method of claim 8 comprising, in response to determining the criteria are met, prompting the LLM with the prompt, where the prompt comprises the alt tag, source code around the alt tag and a request to improve the alt tag; and updating the source code with the technical data.

10. The method of claim 8 comprising, in response to determining the criteria are met, prompting the LLM with the prompt, where the prompt comprises an image associated with the alt tag; and modifying the source code by adding the technical data to the alt tag.

11. The method of claim 8 comprising in response to results from the LLM indicating the alt tag is adequate, determining the criteria are not met and finding a next item in the source data.

12. The method of claim 1 wherein the item is an error message and wherein the method comprises determining whether the criteria are met by prompting the LLM to analyze the error message and, in response to results from the LLM indicating the error message is inadequate, determining the criteria are met.

13. The method of claim 12 comprising, in response to determining the criteria are met, prompting the LLM with the prompt, where the prompt comprises the error message, source code around the error message and a request to improve the error message.

14. The method of claim 1 comprising only storing the technical data or only updating the source data with the technical data, in response to input from an operator.

15. The method of claim 1 comprising adding a command token in the prompt where the command token triggers the LLM to call a search engine using a query comprising key words from the prompt.

16. An apparatus comprising:
a processor;
a memory storing instructions which when executed on the processor implement;
accessing source data comprising source code or data about source code;
finding an item in the source data, where the item is a ticket thread in a bug ticketing system, or an error message in source code, or alt tag in source code;
checking criteria by determining quality of the item, or determining completeness of the item, or by comparing the item with a specification;
in response to the criteria being met for generating technical data related to the item, prompting a large language model (LLM) with a prompt comprising the item;
receiving technical data from the LLM in response to the prompt; and
storing the technical data in association with the source data, or updating the source data using the technical data.

17. The apparatus of claim 16 where the instructions implement checking the criteria are met by searching ticket threads for key words indicating completion of the ticket thread.

18. The apparatus of claim 16 where the instructions implement prompting the LLM with the ticket thread comprising a title, description and comments of the ticket thread.

19. The apparatus of claim 16 where the instructions implement prior to prompting the LLM with the item, prompting the LLM with a technical writer role and writing style.

20. A computer-implemented method comprising:
accessing source data comprising source code or data about source code;
finding an item in the source data, where the item is a ticket thread in a bug ticketing system, or an error message in source code, or alt tag in source code;
checking criteria by determining quality of the item, or determining completeness of the item, or by comparing the item with a specification
in response to the criteria being met for generating technical data related to the item, forming a prompt from the item and a command token;
prompting a large language model (LLM) with the prompt;
receiving technical data from the LLM in response to the prompt; and
storing the technical data in association with the source data, or updating the source data using the technical data.
